(19) United States
(12) Patent Application Publication
(10) Pub. No.: US 2007/0071992 A1
(43) Pub. Date: Mar. 29, 2007

(54) Coating

(76) Inventor: Emmanuel Uzoma Okoroafor, Brickhill, Bedford, Bedfordshire (GB)

Correspondence Address: THE BOC GROUP, INC., 575 MOUNTAIN AVENUE, MURRAY HILL, NJ, 07974-2064, US

(21) Appl. No.: 10/565,585

(22) PCT Filed: Jul. 12, 2004
(86) PCT No.: PCT/GB04/03010

§ 371 Date: Jan. 20, 2006

(30) Foreign Application Priority Data
Mar. 23, 2004 (GB) 0406417.6
Jul. 23, 2003 (GB) 0317126.1

(51) Int. Cl. B05D 3/00; B05D 1/36; B05D 1/02; B29C 71/04; B32B 9/00; C03C 27/00

(52) U.S. Cl. 428/632; 427/421.1; 427/532; 427/299; 427/402; 428/408; 428/469

(57) ABSTRACT

A method of forming a coating on a plastics component of a vacuum pump comprises the steps of applying a metallic layer to the component and forming the coating from the metallic layer by subjecting the metallic layer to electrolytic plasma oxidation.

The present invention relates to a method of forming a coating on a substrate. More specifically but not exclusively, the invention relates to a method of forming a corrosion resistant coating on a machined part used, for example, in a vacuum pump.

Vacuum pumps are used in the manufacture of semiconductor chips to facilitate the control of the various environments that the chip must be exposed to during manufacture. Such pumps are typically manufactured using cast iron and steel components, many of which are precision engineered to ensure optimum performance of the pump. Plastic based parts may also be used as components in vacuum pumps under certain conditions as described below.

Iron castings and steels have for a long time been used in the manufacture of component parts for equipment used in a wide range of industries, including the petrochemical and semiconductor industries. These parts are cheap, exhibit good thermal and thermo-mechanical properties and are relatively easy to form. However, in the semiconductor industries the increasing use of high flow rates of process gases (such as chlorine, boron-trichloride, hydrogen bromide, fluorine and chlorine-trifluoride) together with the associated elevated temperatures and pressures required have resulted in the severe corrosion of the iron and steel component parts. Such corrosion leads to equipment failure, leakage of process chemicals and possible process contamination, and reduced process efficiency, as well as the costs associated with un-planned downtime.

In an attempt to minimise these problems, it has been common practice within many industries to passively protect many of the component parts, since this represents a cheaper alternative to the more expensive active protection that is available. The use of an aluminium coating on iron castings and steels, for example, has been used in a variety of industries to provide good corrosion and heat resistance. In addition, hot-sprayed ceramic coatings applied directly to the metal surface have also been used to protect iron and steel castings in abrasive and high temperature applications.

It has also been suggested that corrosion problems can be overcome by substituting the iron and steel parts with more expensive materials such as nickel rich iron base alloys, Monel, Inconel or higher nickel content alloys. However, these materials are expensive and do not represent a cost efficient alternative for use as component parts.

More recently there has been a move towards the use of plastics-based component parts in a variety of industries in an attempt to replace the metal component parts traditionally used. The versatile nature of plastics means that they can be used to replace metal parts for a variety of reasons. Plastic parts can be manufactured by a variety of means and can be tailored to meet a number of application requirements. In addition their reduced weight and cost in comparison to metals means that they represent an attractive alternative in the manufacture of machine parts. However, because of the susceptibility of these materials to the intensively corrosive, oxidative and aggressive environments encountered in the semi-conductor industry, their use in equipment in this industry has been limited. Most plastic materials will readily wear in the presence of abrasive particles and many hydrocarbon-based plastics may spontaneously combust in the presence of fluorine or oxygen gas.

Many attempts have been made to impart wear and corrosion resistance to a number of plastics materials, the provision of ceramic coatings being particularly popular. However, the application of ceramic coatings to plastic substrates has not always proved easy because, unlike metal surfaces, it is difficult to form ceramic coatings on plastic surfaces that exhibit good adherence and do not flake off in service. This is thought to be due to the non-conductive nature of the plastic surface, which results in the build up of electrostatic charge during the spraying process and acts to repel the sprayed ceramic particles.

There is therefore a need for a corrosion resistant coating that can be easily applied to a metal or plastic substrate and which exhibits good adhesion thereto.

In one aspect, the present invention provides a method of forming a coating on a plastics substrate, the method comprising the steps of applying a metallic layer to the substrate and forming the coating from the metallic layer by subjecting the metallic layer to electrolytic plasma oxidation.

The present invention thus provides a simple and convenient technique for forming an anti-corrosive coating on a plastics component of a vacuum pump. By the term “anti-corrosive” it should be understood to mean that the coating is capable of withstanding wear and degradation as a result of exposure to abrasive particles and gases such as fluorine, chlorine-trifluoride, tungsten-hexafluoride, chlorine, boron-trichloride, hydrogen bromide, oxygen and the like. The coating can be conveniently formed from any suitable barrier layer-forming metal or alloy thereof. By the term “barrier layer-forming metal” it should be understood to mean those metals and their alloys (such as Al, Mg, Ti, Ta, Zr, Nb, Hf, Sb, W, Mo, V, Bi), the surfaces of which naturally react with elements of the environment in which they are placed (such as oxygen) to form a coating layer, which further inhibits the reaction of the metal surface with said reactive environmental elements.

The technique of electrolytic plasma oxidation (EPO) is known by various other names, for example anodic-plasma oxidation (APO), anodic spark oxidation (ASO), micro-arc oxidation (MAO). During this technique, a partial oxygen plasma forms at the metal/gas/electrolyte phase boundary and results in the creation of a ceramic oxide layer. The metal ion in the ceramic oxide layer is derived from the metal and the oxygen formed during the anodic reaction of the aqueous electrolyte at the metal surface. At temperatures of 7000K associated with the formation of the plasma, the ceramic oxide exists in a molten state. This means that the molten ceramic oxide can achieve intimate contact with the metal surface at the metal/oxide boundary, which means that the molten ceramic oxide has sufficient time to contract and form a sintered ceramic oxide layer with few pores. At the electrolyte/oxide boundary, however, the molten ceramic oxide is quickly cooled by the electrolyte and the gases flowing away, notably oxygen and water vapour, leaving an oxide ceramic layer with increased porosity.

Thus, the ceramic oxide coating so formed is itself characterised by three layers or regions. The first is a transitional layer between the metallic layer and the coating where the metal surface has been transformed, resulting in excellent adhesion for the coating. The second is the functional layer, comprising a sintered ceramic oxide containing hard crystallites that give the coating its high hardness and wear resistance characteristics. The third is the surface layer, which has lower hardness and higher porosity than the functional layer.

It will be appreciated from the foregoing that the ceramic oxide coating is atomically bound to the underlying metallic layer and is formed from the surface of the metallic layer. This means that the ceramic oxide coating so produced exhibits greater adhesion to the underlying metallic layer than would be formed from externally applied sprayed ceramic coating. The ceramic oxide coating exhibits superior surface properties such as extreme hardness, very low wear, detonation and cavitation resistance, good corrosion and heat resistance, high dielectric strength and a low coefficient of friction. In addition, it is also resistant to corrosion from halogens, inter-halogen compounds and other semiconductor processing chemicals excited by plasma.

From the foregoing it will be appreciated that the external surface of the coating is in some applications characterised by a low porosity. In such situations out-gassing from the coated substrate material is minimised. In other applications, the external surface of the coating may be irregular and exhibit some porosity. In order to ensure extreme hardness, low wear and good corrosion resistance, the external surface of this coating may be removed by grinding to expose the underlying sintered ceramic oxide layer, which provides the superior surface properties referred to above.

Alternatively, where the external surface of the coating exhibits some porosity it can serve as a matrix for application of an optional layer of a composite nature. In such situations, materials suitable for forming the composite layer include a lubricant or paint, for example. It will be appreciated that the pore sizes of the external surface of the second layer are of a size that are capable of retaining the material of the third layer. Other examples of such composite coatings include lubricants such as fluorocarbons, polytetrafluoroethylene (PTFE), molybdenum disulfide (MoS₂), graphite and the like, which are retained by the porous external surface of the coating. The optional layer is preferably formed directly over the coating, the coating providing a key for the adhesion of this additional layer.

In one embodiment, the metallic layer is not formed directly on the surface of the substrate, but is formed on the surface of a metallic layer previously applied to the substrate. Applying this metallic layer, formed, for example, from nickel, on the surface of the substrate can improve the properties of the surface on which the subsequent metallic layer is deposited. Furthermore, a coating formed from nickel, aluminium, and ceramic oxide layers would offer superior corrosion, wear resistance and heat transfer capability to a metallic substrate, such as an aluminium alloy used in the manufacture of high speed vacuum pumps. Therefore, in another aspect the present invention provides a method of forming a coating on a metallic or plastics substrate, the method comprising the steps of applying a first metallic layer to the substrate, applying a second metallic layer over the first metallic layer, and forming the coating from the second metallic layer by subjecting the second metallic layer to electrolytic plasma oxidation.

The (second) metallic layer is suitably applied by depositing a layer of the barrier layer-forming metal or alloy thereof directly or indirectly (depending on substrate) onto the substrate surface to a thickness of preferably less than 100 μm. The metallic layer is preferably deposited onto the surface of the substrate using one of (i), sifting or compression of metallic powder or wrapping of the foil onto a liquid adhesive, after it has been applied to the surface (ii), electrolytic-deposition onto an initially deposited metal layer (iii), spraying techniques such as sputtering, plasma-spraying, arc-spraying, flame-spraying, vacuum-metallising, ion-vapour deposition, high velocity oxyfuel-spraying, cold gas-spray; combinations thereof and the like, which are well known to a skilled person. These methods ensure that the metal or alloy thereof is both well adhered to and does not degrade the underlying substrate. Whatever procedure or combination thereof adopted, the parameters must be adjusted to values suitable to obtain homogeneous coatings, with low porosity value and free of cast-in (embedded) particles, oxides and cracks that will compromise the formation of the ceramic oxide coating by electrolytic plasma oxidation. For both metal and plastic substrates, the deposition of a metallic layer on the surface of the substrate has little effect on the bulk temperature of the substrate, thereby preventing distortion thereof. When employing the hot spraying techniques, the superior wetting properties of the molten metal particles on the substrate surface, when compared to conventionally sprayed ceramic particles, lead to the formation of a metallic layer having a low is porosity.

As indicated above, the coating is formed by electrolytic plasma oxidation of the surface of the metallic layer. The coating is suitably formed by immersing an anodically charged metal coated part in an alkaline electrolyte (e.g., aqueous solution of an alkali metal hydroxide and sodium silicate) using a stainless steel bath acting as the counter electrode and applying an AC voltage in excess of 250V to the part. During this technique, a partial oxygen plasma forms at the metal/gas/electrolyte phase boundary and results in the creation of a ceramic oxide layer. The metal ion in the ceramic oxide layer is derived from the metal and the oxygen formed during the anodic reaction of the aqueous electrolyte at the metal surface. At temperatures of 7000K associated with the formation of the plasma, the ceramic oxide exists in a molten state. This means that the molten ceramic oxide can achieve intimate contact with the metal surface at the metal/oxide boundary, which means that the molten ceramic oxide has sufficient time to contract and form a sintered ceramic oxide layer with few pores. At the electrolyte/oxide boundary, however, the molten ceramic oxide is quickly cooled by the electrolyte and the gases flowing away, notably oxygen and water vapour, leaving an oxide ceramic layer with increased porosity. The bath temperature is maintained constant at about 20° C. A constant current density of at least 1 A/dm² is maintained in the electrolytic bath until the voltage reaches a predetermined end value, consistent with the formation of an insulating layer. Under these conditions, one obtains typically about 1 sum of ceramic oxide coating per minute. Ceramic coating thickness up to about 100 μm can be obtained in 60 minutes, depending on barrier forming metal type and alloy. The required current density to initiate the plasma process may be as high as 25 A/dm² if the applied metallic layer is rough and porous.

The electrolytic plasma oxidation is preferably carried out in a weak aqueous alkaline electrolyte of pH in the range from 7 to 8.5, preferably in the range from 7.5 to 8, at temperatures of about 20° C., which means that the integrity of the substrate material is little affected. As indicated above the melting that occurs during the formation of the ceramic coating tends to fill out any pores in the underlying metallic layer, resulting in an impermeable interfacial region between the layers.

For plastic substrates the formation of the ceramic oxide coating over the underlying metallic layer overcomes the problems of electrostatic repulsion commonly encountered when depositing ceramic particles directly onto the surfaces of plastic substrates.

The substrate is preferably a component of a vacuum pump, and so the present invention also provides a vacuum pump component formed from metallic or plastics material and having a coating thereon formed by electrolytic plasma oxidation of a metallic layer applied to the component.

Preferred features of the present invention will now be described, by way of example only, with reference to the accompanying drawings in which:

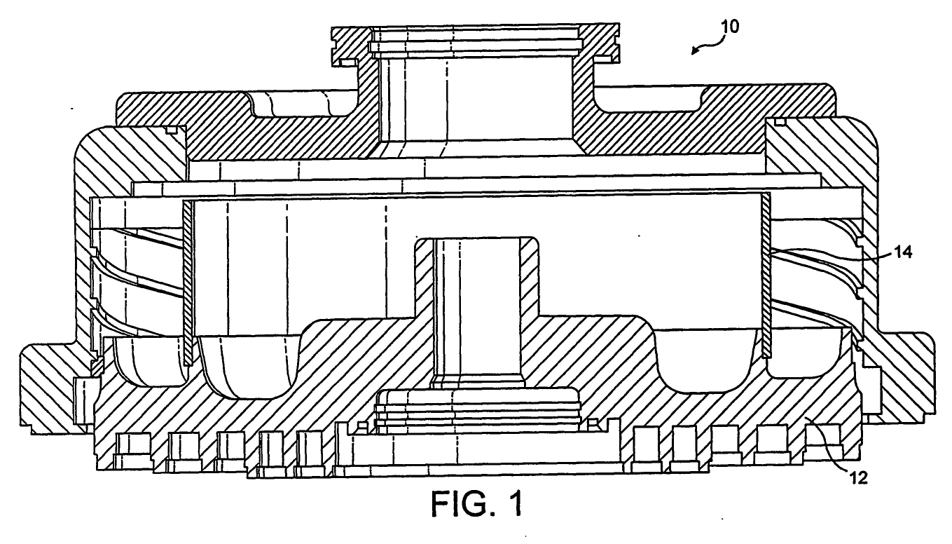

FIG. 1 is a simplified cross-section of a rotor of a vacuum pump.

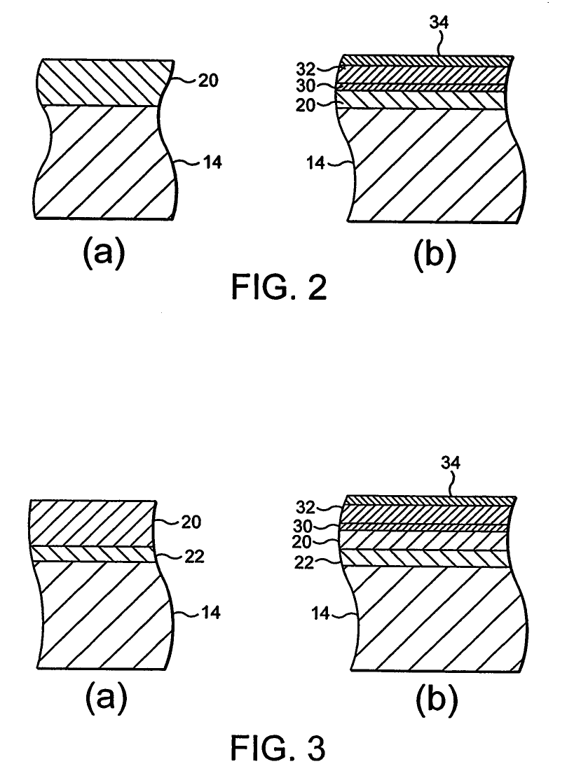

FIG. 2 illustrates steps in the formation of a coating on a component of the rotor in a first embodiment of the invention. FIG. 2(a) is a cross-section of part of the component prior to electrolytic plasma oxidation, and FIG. 2(b) is a cross-section of that part following the electrolytic plasma oxidation.

FIG. 3 illustrates steps in the formation of a coating on a component of the rotor in a second embodiment of the invention. FIG. 3(a) is a cross-section of part of the component prior to electrolytic plasma oxidation, and FIG. 3(b) is a cross-section of that part following the electrolytic plasma oxidation.

In the present invention, one can achieve adherent and coherent ceramic coatings on iron castings, steels and plastics in a relatively simple and cost-effective manner that will also allow its application to precision parts with tight tolerances. An example of such a part is a component of a vacuum pump, and in particular a component of a rotor of a vacuum pump. With reference to FIG. 1, a known compound vacuum pump 10 comprises a regenerative section and a molecular drag (Holweck) section. A rotor 12 rotatably mounted on a drive shaft (not shown) carries the rotor elements for both the regenerative section and the Holweck section. The rotor elements for the Holweck section comprise one or more concentric cylinders or tubes 14 (one only shown in FIG. 1) mounted on the rotor 12 such that the longitudinal axes of the tubes 14 are parallel to the axes of the rotor 12 and the drive shaft. These tubes are typically formed from carbon-fibre reinforced epoxy resin.

The general method for applying a coating to such components of a vacuum pump is set out below, with specific examples presented thereafter.
(1.) An optional initial treatment to roughen the surface of the component. Such methods may include peening and blasting, pickling and/or combinations thereof. For plastics, application of a thin layer of liquid adhesive, such as polyimides or epoxies, or metal such as nickel, may follow the surface roughening.
(2.) Deposition of a light metal (e.g., Al, Ti, Mg, and their alloys) or alloy (Al—Ni, Al—Cu, Al—Zn, Al—Mg, etc) onto the (optionally) roughened surface (which may include a thin layer of liquid adhesive or metal), using techniques such as sifting or compression of the metal powder or wrapping of the metal foil onto the applied adhesive layer, or electro-deposition of the metal on to an initially-applied metal layer, vacuum-metallising, sputtering, plasma-spraying, arc-spraying, flame-spraying, high-velocity-oxy-fuel-spraying, and combinations thereof. In the case of a plastic component, the most promising coating techniques are the compression of the metal powder or wrapping of the metal foil onto an applied liquid adhesive layer or electro-deposition of the metal on to initially-applied metal layer, the plasma spraying, the high velocity oxy-fuel spraying and combinations thereof, as these exhibit a low thermomechanical load with respect to other technologies. It will be appreciated that the above-mentioned spraying techniques have little thermo-mechanical impact on a metal substrate. With reference to the figures, FIG. 2(a) is a cross-sectional view of an example where the metallic layer 20 is deposited directly on to the surface of the component 14, whilst FIG. 3(a) is a cross-sectional view of an example where the metallic layer 20 is deposited on to a metallic layer 22 initially applied to the component 14.
(3.) Electrolytic plasma oxidation of the surface of the metallic layer to generate a ceramic oxide coating. FIG. 2(b) is a cross-sectional view of the example of FIG. 2(a) following oxidation, and FIG. 3(b) is a cross-sectional view of the example of FIG. 3(a) following oxidation. It is important that not all the metallic layer 20 is converted to ceramic. The ceramic oxide coating so formed is itself characterised by three layers or regions. The first layer 30 is a transitional layer between the metallic layer 20 and the coating where the metal surface has been transformed, resulting in excellent adhesion for the coating. The second layer 32 is the functional layer, comprising a sintered ceramic oxide containing hard crystallites that give the coating its high hardness and wear resistance characteristics. The third layer 34 is the surface layer, which has lower hardness and higher porosity than the functional layer 32.
(4.) Optional finishing treatment of the surface of the ceramic coating using techniques such as keying in of substances (for example, CFₓ, fluorocarbons, PTFE, MOS₂ and graphite, Ni, Cr, Mo, W and their Carbides, paints and resins), grinding, polishing, tumbling, rumbling, etc and combinations thereof.

The invention will now be described with reference to the following non-limiting examples. Variations on these failing within the scope of the invention will be apparent to a person skilled in the art.

### EXAMPLE 1

A composite tube, manufactured in epoxy resin comprising carbon fibres (fibre direction to satisfy thermo-mechanical strain matching with metallic rotor parts), was subjected to the coating process. The surface of the tube was subjected to a low pressure grit blast using 60 mesh grit or light peening using bauxite. Thermal sandblasting may also be used. All methods serve to remove the sheen from the surface of the tube, thereby to roughen the surface without damaging the fibres. The surface was then wiped with alcohol and dried to remove grease therefrom.

Aluminium and aluminium-nickel alloy (80/20) having powders of nominal size ˜10 μm were plasma sprayed onto the tube using a standard Ar/H₂ plasma, nominally of 40 kW power level. It is to be noted that use of standard powders with nominal dimension 45-90 μm tend to give a more porous coat. Each powder type resided for about 0.1 ms in the plasma at ˜15000° C. before being projected onto the tube, revolving at 60 rpm, from a distance of 150 to 180 mm. The speed of the particles impinging on the tube was in range from 225 m/s-300 m/s, thus permitting splaying out (or wetting) of the molten particles and with some degree of penetration into the tube. The average surface temperature during the plasma spraying process was in the range 100-150° C. The coating thickness was controlled by the duration of the spraying. Following the spraying, the tube was slowly cooled in still air, grit blast to densify the coating, and the surface machined by grinding with a 180 SiC grinding wheel to remove the surface roughness, leaving a final thickness of the metallic layer thus formed on the tube of about 50 μm.

The metallic layer applied as described above was subject to electrolytic plasma oxidation in an electrolyte (an aqueous solution of an alkali metal hydroxide and sodium silicate or sodium aluminate, or sodium metaphosphate), at a pH of 7.6. Using a current density of 12 A/dm²; an electrolyte temperature of 20±3° C., and a coating time of 60 minutes, a voltage end value of 350V was registered. The component with the thus-formed ceramic coating was washed and dried. The thickness of the ceramic coating was 30 μm.

The corrosion resistance of the composite tube coated in this manner has four times better corrosion resistance than un-coated epoxy-carbon fibre composite tube in semiconductor applications. In particular it was found that a BOC Edwards IPX pump having components coated with the ceramic coating lasted four times longer than un-coated pumps when exposed to 4500 litres each of chlorine, bromine and fluorine.

As a final, optional treatment, the ceramic-coated component was immersed and moved within an aqueous anionic PTFE dispersion having a particle size of ˜0.3 μm, washed under a flow of hot water (90° C.) and dried with hot air to enhance the corrosion resistance of the coating.

### EXAMPLE 2

A similar composite tube of example 1 was subjected to a low pressure grit blast using 60 mesh grit to remove the sheen from the surface of the composite, thereby to roughen the surface without damaging the fibres. The surface was then wiped with alcohol and dried to remove grease therefrom, prior to application of a thin liquid layer of epoxy adhesive using a paintbrush.

Aluminium and aluminium-nickel alloy (80/20) having powders of nominal size ˜10 μm were compressed onto the surface of the tube by rolling compaction over a bed of the metal powder. Cure of the adhesive was achieved by placing the powder-coated tube for 1 hour in an oven pre-set to 120° C. The coating had an inner layer where the metal powder was intermixed with the adhesive and an outer layer where the powder was keyed onto the inner layer. Then the surface were machined by grinding with a 180 SiC grinding wheel to remove the surface roughness, leaving a final ground metallic layer thickness of about 30 μm.

The metallic layer applied as described above was subject to electrolytic plasma oxidation in an electrolyte, (an aqueous solution of an alkali metal hydroxide and sodium silicate or sodium aluminate, or sodium metaphosphate), at a pH of 7.6. Using a current density of 20 A/dm²; an electrolyte temperature of 20±3° C., and a coating time of 75 minutes, a voltage end value of 400V was registered. The tube with the thus-formed ceramic coating was washed and dried. The thickness of the ceramic coating was 10 μm. The corrosion resistance of the composite tube coated in this manner has four times better corrosion resistance than un-coated epoxy-carbon fibre composite tube in semiconductor applications.

The ceramic-coated tube can be optionally coated to enhance the corrosion resistance of the coating as in example 1.

### EXAMPLE 3

Samples from example 2 above, with the ground metallic layer only, were further subjected to plasma spraying of aluminium and aluminium alloy powders under the conditions used in example 1. Following spraying, the tube was slowly cooled in still air and grit blast to densify the coating. Then the surfaces were machined by grinding with a 180 SiC grinding wheel to remove the surface roughness, leaving a final ground metallic layer thickness of about 60 μm.

The metallic layer applied as described above was subject to electrolytic plasma oxidation in an electrolyte, (an aqueous solution of an alkali metal hydroxide and sodium silicate or sodium aluminate, or sodium metaphosphate), at a pH of 7.6. Using a current density of 12 A/dm²; an electrolyte temperature of 20±3° C., and a coating time of 60 minutes, a voltage end value of 350V was registered. The tube with the thus-formed ceramic coating was washed and dried. The thickness of the ceramic coating was 40 μm. The corrosion resistance of the composite tube coated in this manner has four times better corrosion resistance than un-coated epoxy-carbon fibre composite tube in semiconductor applications.

The ceramic-coated tube can be optionally coated to enhance the corrosion resistance of the coating as in example 1.

### EXAMPLE 4

A similar composite tube of example 1 was subjected to a low pressure grit blast using 60 mesh grit to remove the sheen from the surface of the composite, thereby to roughen the surface without damaging the fibres. The surface was then wiped with alcohol and dried to remove grease therefrom, prior to application of a thin liquid layer of epoxy adhesive using a paintbrush.

An aluminium foil with a thickness of ˜50 μm was wrapped onto the liquid adhesive. The outer diameter of the tube was coated by press rolling the tube over a cut section of the foil, and with the excess trimmed off, leaving an overlap length of ˜1 mm. For the inner diameter, a similar cut section of the foil was gently laid around the surface, followed by consolidation with a roller, and with the excess trimmed off, leaving an overlap length of ˜1 mm. Cure of the adhesive was achieved by placing the foil-coated tube for 1 hour in an oven pre-set to 120° C.

The metallic layer applied as described above was subject to electrolytic plasma oxidation in an electrolyte, (an aqueous solution of an alkali metal hydroxide and sodium silicate or sodium aluminate, or sodium metaphosphate), at a pH of 7.6. Using a current density of 6 A/dm²; an electrolyte temperature of 20±3° C., and a coating time of 45 minutes, a voltage end value of 300V was registered. The tube was subsequently washed and dried. The thickness of the ceramic coating formed on the tube was 35 μm. The corrosion resistance of the composite tube coated in this manner has four times better corrosion resistance than un-coated epoxy-carbon fibre composite tube in semiconductor applications.

The ceramic-coated tube can be optionally coated to enhance the corrosion resistance of the coating as in example 1.

### EXAMPLE 5

A similar composite tube of example 1 was cleaned and the surface modified by roughening and activation, using grit blasting or its combination with plasma etching.

The modified polymer surface was then activated by Pd/Sn colloids to provide sites for deposition of a nickel layer by means of electroless nickel plating. An electrolytic process that permits deposition of an aluminium layer onto the nickel layer (serving as bond coat) then follows. The typical coating thickness for the nickel layer was in the range from 5 to 25 μm, and the thickness of the overcoat aluminium layer was in the range from 15 to 50 μm. The coating so obtained was very adherent to the composite tube, smooth, non-porous and impermeable to fluids.

The metallic layer applied as described above was subject to electrolytic plasma oxidation in an electrolyte, (an aqueous solution of an alkali metal hydroxide and sodium silicate or sodium aluminate, or sodium metaphosphate), at a pH of 7.6. Using a current density of 4 A/dm2; an electrolyte temperature of 20±3° C., and a coating time of 10 minutes, a voltage end value of 350V was registered. The tube was subsequently washed and dried. The thickness of the ceramic coating formed on the tube was 15 μm. The corrosion resistance of the composite tube coated in this manner has six times better corrosion resistance than un-coated is epoxy-carbon fibre composite tube in semiconductor applications.

The ceramic-coated tube can be optionally coated to enhance the corrosion resistance of the coating as in example 1.

### EXAMPLE 6

In this example, a SG iron sample, 100 mm×100 mm×5 mm, and a mild steel sample, 100 mm×100 mm×5 mm, were subjected to the coating process. The surfaces of the samples were roughened by sandblasting, followed by a pickling in a 10% HF aqueous solution at room temperature for 60 minutes. The samples were then washed and dried.

The samples were then subject to plasma spraying of aluminium and aluminium alloy powders under the conditions used in example 1. Following spraying, the samples were slowly cooled in still air and grit blast to densify the coating. Then the surfaces were machined by grinding with a 180 SiC grinding wheel to remove the surface roughness, leaving a final ground metallic layer thickness of about 50 μm

The metallic layers applied as described above were subjected to electrolytic plasma oxidation in an electrolyte (an aqueous solution of an alkali metal hydroxide and sodium silicate or sodium aluminate, or sodium metaphosphate) with a pH of 7.6. Using a current density of ˜8 A/dm², an electrolyte temperature of 20±3° C. and a coating time of 60 minutes, a voltage end value of 300V was registered. The samples were washed and dried. The thickness of the ceramic coating formed on the samples was ˜30 μm. SG iron coated in this manner has four times better corrosion resistance than un-coated SG iron in semiconductor applications.

The ceramic-coated samples can be optionally coated to enhance the corrosion resistance of the coating as in example 1.

1. A method of forming a coating on a plastics substrate comprising the steps of:
applying a metallic layer to the substrate wherein the metallic layer is selected from the group of metals consisting of magnesium, titanium, tantalum, zirconium, neobydium, hafnium, tin, tungsten, molybdenum, vanadium, antimony, bismuth, and alloys of the aforementioned metals; and
subjecting the metallic layer to electrolytic plasma oxidation.

2. The method according to claim 1, wherein the group of metals further includes aluminium.

3. The method according to claim 1 wherein the metallic layer is deposited on the substrate.

4. The method according to claim 3 wherein the metallic layer is sprayed on the substrate.

5. The method according to claim 1 wherein the metallic layer is adhered to the substrate.

6. The method according to claim 1 wherein the metallic layer comprises a thickness less than 100 um.

7. The method according to claim 1 wherein the substrate is roughened prior to applying the metallic layer thereto.

8. The method according to claim 1 wherein the metallic layer is formed on a second metallic layer previously applied to the substrate.

9. The method according to claim 1 wherein the metallic layer is formed on a polymeric layer previously applied to the substrate.

10. The method according to claim 1 wherein the substrate comprises an epoxy-carbon fibre composite or fibre reinforced plastics material.

11. The method according to claim 1 farther including the step of smoothening the metallic layer prior to the step subjecting the metallic layer to electrolytic plasma oxidation.

12. The method according to claim 1 wherein the electrolytic plasma oxidation is performed at a pH from 7 to 8.5.

13. The method according to claim 1 wherein the coating comprises a thickness less than 100 um.

14. The method according to claim 13 wherein the thickness is less than 50 um.

15. The method according to claim 1 further comprising the step of modifying a physical property of the coating after the step of subjecting the metallic layer to electrolytic plasma oxidation.

16. The method according to claim 1 further comprising the step of at least partially removing an external layer from the metallic layer after the step of subjecting the metallic layer to electrolytic plasma oxidation.

17. The method according to claim 1 further comprising the step of abrasively removing at least part of the metallic layer after the step of subjecting the metallic layer to electrolytic plasma oxidation.

18. The method according to claim 1 further comprising the step of applying a material for reducing the porosity of the coating to the metallic layer after the step of subjecting the metallic layer to electrolytic plasma oxidation.

19. The method according to claim 1 further comprising the step of applying a material for enhancing the corrosion resistance of the coating to the metallic layer after the step of subjecting the metallic layer to electrolytic plasma oxidation.

20. The method according to claim 1 further comprising the step of applying a layer comprising at least one organic material selected from the group consisting of a fluorocarbon, polytetrafluoroethylene, Carbon, carbides of Ni, Cr, Mo and W, a paint and a resin after the step of subjecting the metallic layer subjected to electrolytic plasma oxidation.

21. A method of forming a coating on a metallic or plastics substrate comprising the steps of:
applying a first metallic layer to the substrate;
applying a second metallic layer on at least a portion of the first metallic layer;
and subjecting the second metallic layer to electrolytic plasma oxidation to form the coating.

22. The method according to any claim 21 wherein the substrate comprises a component of a vacuum pump.

23. A vacuum pump component comprising:
a metallic layer on the component and wherein the metallic layer is subjected to electrolytic plasma oxidation.

24. The method according to claim 1 wherein the substrate is a component of a vacuum pump.

25. The method according to claim 1 further comprising the step of treating an external surface of the coating to modify a chemical property of the coating.

26. The method according to claim 1 further comprising the step of applying to the metallic layer subjected to electrolytic plasma oxidation a layer formed from at least one metal selected from the group consisting of Mo, Ni, Cr and W.

27. A method of forming a coating on a metallic or plastics substrate comprising the steps of:
applying a layer comprising nickel to the substrate;
applying a layer comprising aluminum to the nickel layer; and
subjecting the aluminum layer to electrolytic plasma oxidation.

28. A vacuum pump component having a surface comprising:
a metallic layer on the surface wherein the metallic layer is selected from the group of metals consisting of aluminum, magnesium, titanium, tantalum, zirconium, neobydium, hafnium, tin, tungsten, molybdenum, vanadium, antimony, bismuth, and alloys of the aforementioned metals; and
wherein the metallic layer is subjected to electrolytic plasma oxidation.

29. A vacuum pump comprising:
a component; and
a metallic layer on the component wherein at least a portion of the metallic layer is oxidized by electrolytic plasma oxidation.

30. The vacuum pump of claim 29 wherein the component is selected from the group of vacuum pump components consisting of a composite tube, a regenerative section, a molecular section, a pipe, a housing, a rotor and a stator.

31. The vacuum pump of claim 29 wherein the component comprises a metal.

32. The vacuum pump of claim 29 wherein the component comprises a plastic.

33. The vacuum pump of claim 29 wherein the component comprises an epoxy-carbon fiber composite or fiber reinforced plastics material.

34. The vacuum pump of claim 29 wherein the metallic layer is selected from the group of metals consisting of aluminum, magnesium, titanium, tantalum, zirconium, neobydium, hafnium, tin, tungsten, molybdenum, vanadium, antimony, bismuth, and alloys of the aforementioned metals and wherein the metallic layer is subjected to electrolytic plasma oxidation.

35. The vacuum pump of claim 29 wherein the at least a portion of the metallic layer oxidized by electrolytic plasma oxidation comprises a ceramic.

36. The vacuum pump of claim 35 wherein the ceramic comprises a transitional layer.

37. The vacuum pump of claim 36 wherein the ceramic further comprises a functional layer comprising a sintered ceramic oxide having a hard crystallite.

38. The vacuum pump of claim 37 wherein the ceramic further comprises a surface layer having a lower hardness value and a higher porosity value than the hardness and porosity values of the functional layer.

39. A vacuum pump component having a ceramic coating comprising:
a metallic layer having an outer surface;
wherein the metallic layer comprises:
a surface layer extending inwardly from the outer surface of the metallic layer;
a functional layer extending inwardly from the surface layer;
a transitional layer extending inwardly from the functional layer; and
an unreacted metallic layer extending inwardly from the transitional layer.

40. The vacuum pump component of claim 39 wherein at least one of the surface layer, the functional layer and the transitional layer is formed by exposing at least a portion of the metallic layer to electrolytic plasma oxidation.

41. The vacuum pump of claim 39 wherein the transitional layer is an adhesive for the ceramic coating.

42. The vacuum pump of claim 39 wherein the functional layer comprises a sintered ceramic oxide having a hard crystallite.

43. The vacuum pump of claim 39 wherein the surface layer has a lower hardness value and a higher porosity value than the hardness and porosity values of the functional layer.
